(19) United States
(12) Patent Application Publication
(10) Pub. No.: US 2011/0156382 A1
(43) Pub. Date: Jun. 30, 2011

(54) SECURITY DOCUMENT AND METHODS OF PRODUCING IT

(75) Inventor: Carlo Uyttendaele, Mortsel (BE)

(73) Assignee: Agfa-Gevaert N.V., Mortsel (BE)

(21) Appl. No.: 13/062,375

(22) PCT Filed: Oct. 15, 2009
(86) PCT No.: PCT/EP09/63483

§ 371 Date: Mar. 4, 2011

Related U.S. Application Data
(60) Provisional application No. 61/114,513, filed on Nov. 14, 2008.

(30) Foreign Application Priority Data
Nov. 4, 2008 (EP) 08168231.2

(51) Int. Cl. B42D 15/10; B29C 35/08

(52) U.S. Cl. 283/91; 283/85; 264/482

(57) ABSTRACT

A security document having in order a) a first laser markable layer, present as a self-supporting layer or as a layer on a support; b) at least one polymeric overlay; and c) a second laser markable layer; wherein the second laser markable layer exhibits a higher laser sensitivity than a non-laser marked area of the first laser markable layer but produces a smaller maximum optical density or a smaller gloss on laser marking. Methods for manufacturing the security document are also disclosed.

### TECHNICAL FIELD

This invention relates to the security of information or data carriers, more particularly to securing cards and passports so that the identification data are not altered or modified and that the cards cannot thus be reused fraudulently.

### BACKGROUND ART

Security cards are widely used for various applications such as identification purposes (ID cards), financial transfers (credit cards) e-health or social security. Such cards typically consist of a laminated structure consisting of various paper or plastic layers wherein one or more layers carry information, e.g. alphanumeric information, logos, a picture of the card holder, etc.

Electronic cards wherein the user can store digital information are also known, e.g. cards comprising a magnetic strip, optically recordable cards or cards comprising an electronic chip, so called ‘smart cards’.

A principal objective of such security cards is that it cannot be easily modified or reproduced in such a way that the modification or reproduction is difficult to distinguish from the original. Therefore, security cards are provided with security features which are difficult to modify or reproduce, e.g. a “security seal” between the information layer and a protective sheet bonded to it. Upon an attempt to separate the protective sheet from the information layer, the security seal is destructed or removed so that it becomes clear that the information carried by the card has been tampered with or altered. Such a security seal can, for example, be provided by applying heat-sealable polymers so as to obtain a sealed envelope-type pouch, as described in e.g. U.S. Pat. No. 4,322,461 (POLAROID) and references therein.

However methods have been found for modifying information on a security card wherein the security seal either remains un-destructed or need not to be removed.

Information can be added to a card using various imaging techniques such as inkjet, electrophotography, dye sublimation, laser marking, laser engraving and silver diffusion transfer imaging. In literature, laser engraving is often incorrectly used for laser marking. While carbonization of material occurs in laser marking, in laser engraving the material is ablated. For example, WO 03/055638 (DIGIMARC) discloses an identification document wherein a pattern of holes is laser etched, i.e. laser engraved, into the top surface of the identification document. Laser marking is disclosed by e.g. US2004/0198858 (DIGIMARC) using laser enhancing additives such as copper potassium iodide (CuKI3), Copper Iodide (CuI), potassium iodide (KI), sodium iodide (NaI), aluminum iodide (AlI), zinc sulfide (ZnS), barium sulfide (BaS), alkyl sulfonate, and thioester.

Laser engraving can also be used as a manufacturing technique for creating other type of security features. For example, DE 102007024298 discloses a security document wherein a relief pattern can be obtained by laser engraving instead of embossing in order to create a luminescent pattern.

The imaging techniques can be categorized into “additive” imaging techniques, e.g. inkjet, and “subtractive” imaging techniques, e.g. laser engraving. Often in falsifying security cards, the addition of information has been proven to be easier than the subtraction of information. For example, it is possible to completely change a photograph by adding more hair, a moustache, glasses etc. Many approaches have been developed to hinder or prevent falsification.

One approach involves a change of the information content on the security document. For example, WO 2008/084315 (AXALTO) discloses a secure identification document comprising a first set of identification data and a second set of identification data obtained by duplicating the first set of identification data, which takes the form of a reverse image of the first set of identification data. A disadvantage of including an image and its reverse image is the reduction of space available for other type of information.

Another approach involves the addition of security features such as, for example, a watermark as in U.S. Pat. No. 7,097,899 (AGFA) or the use of a lenticular lens in US 2003183695 (DIGIMARC). Generally, the addition of such security features represents an increase in the cost of manufacturing security documents.

However, since methods for falsification and counterfeiting of security documents also continue to develop and improve, it remains a constant battle to protect security documents against falsification and counterfeiting. Therefore a need exists to provide simple and cost-effective methods for securing documents.

### DISCLOSURE OF INVENTION

### Summary of the Invention

In order to overcome the problems described above, preferred embodiments of the present invention provide a security document as defined by Claim 1.

It is a further object of the present invention to provide a method of manufacturing a security document which is both simple and cost-effective to implement, yet provides security documents which are difficult to falsify.

Further advantages and embodiments of the present invention will become apparent from the following description.

### BRIEF DESCRIPTION OF FIGURES IN THE DRAWINGS

FIG. 1 shows an example of photograph forgery by adding darkened areas on a security card. The original security card 1 contains data about the identity of the holder in a text area 2 and a laser marked image 3. The original image 3 of the security card 1 has been modified by the addition of hair and a moustache through laser marking, so that there is a new forged image 3A on the security card 1A.

FIG. 2 shows a schematic sectional view of a security document precursor having a support 21, a first laser markable layer 22 and a polymeric overlay 23.

FIG. 3 shows a schematic sectional view of a “symmetrical” security document precursor having a support 21, and on both sides of the support first laser markable layers 22 and polymeric overlays 23.

FIG. 4 shows a schematic sectional view of a “symmetrical” security document precursor of FIG. 3 which has been laser marked with information in one of the first laser markable layers 22 on the support 21 and covered by the polymeric overlay 23. On the side of the support 22 carrying the laser markings, a second laser markable layer 24 is present on the polymeric overlay 23.

FIG. 5 shows the example of FIG. 4 wherein the other first laser markable layer 22 has also been laser marked.

FIG. 6 shows an example of an attempt to falsify a symmetrical security document by laser marking a second laser markable layer 24, but wherein a lower maximal optical density was obtained.

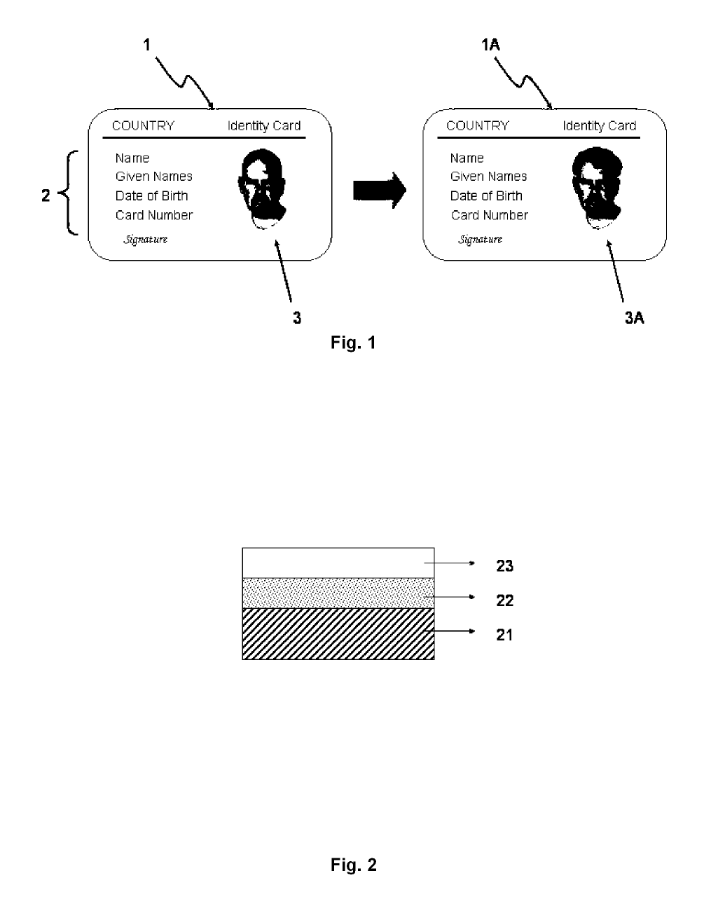

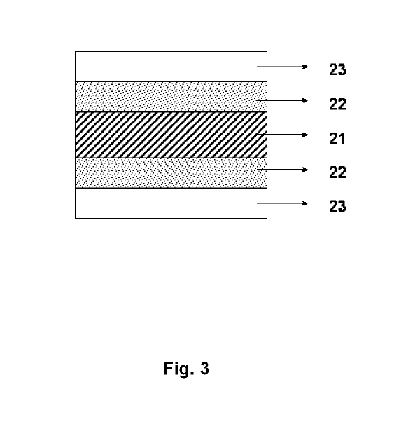

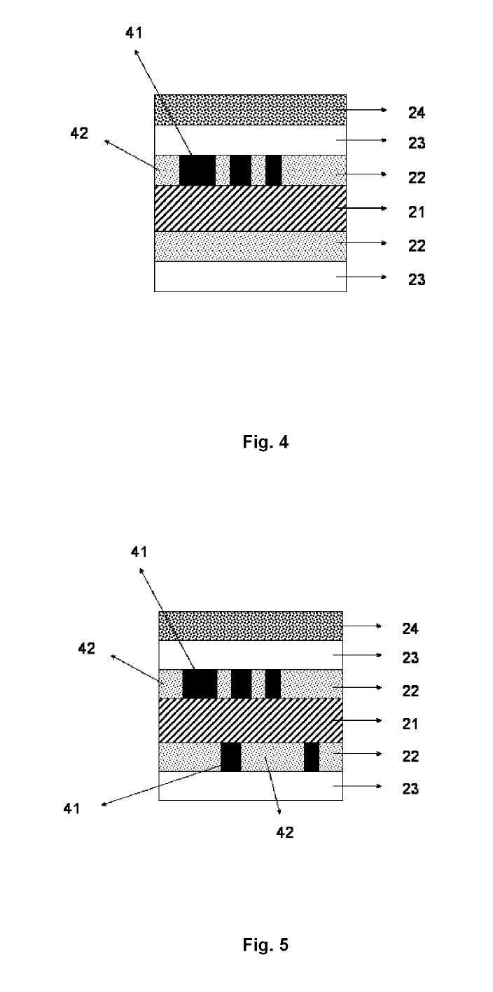

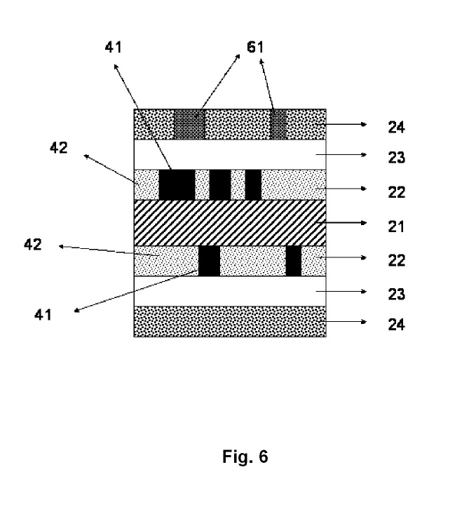

### DEFINITIONS

The definitions of security features correspond with the normal definition as adhered to in the “Glossary of Security Documents—Security features and other related technical terms” as published by the Consilium of the Council of the European Union on Aug. 25, 2008 (Version: v.10329.02.b.en) on its website: http://www.consilium.europa.eu/prado/EN/glossaryPopup.html.

The term “dye”, as used in the preferred embodiments of the present invention, means a colorant having a solubility of 10 mg/L or more in the medium in which it is applied and under the ambient conditions pertaining.

The term “pigment” is defined in DIN 55943, herein incorporated by reference, as a colouring agent that is practically insoluble in the application medium under the pertaining ambient conditions, hence having a solubility of less than 10 mg/L therein.

“PETG” is an abbreviation for polyethylene terephthalate glycol, the glycol indicating glycol modifiers which are incorporated to minimize brittleness and premature aging that occur if unmodified amorphous polyethylene terephthalate (APET) is used in the production of cards.

### Security Documents

The security document according to the present invention includes in order a support, a first laser markable layer, a polymeric overlay and a second laser markable layer wherein the second laser markable layer exhibits a higher laser sensitivity than a non-laser marked area of the first laser markable layer but produces a smaller maximum optical density or a smaller gloss on laser marking.

The difference in sensitivity between the first laser markable layer and the second laser markable layer can be obtained in various ways, for example, by the choice of the materials in the laser markable layers or by adapting the construction of the security document.

In one embodiment, the second laser markable layer is intrinsically more sensitive than the first laser markable layer due to a different composition of the layer. This can be accomplished in different ways well-known to the skilled person.

In another embodiment, the construction of the security document is adapted by interposing a layer between the first and second laser markable layer which reduces the infrared light transmission to no more than 90%, at a wavelength between 750 and 1400 nm, i.e. at the wavelength of the laser used for laser marking. The interposed layer reduces the amount of infrared light which reaches the first laser markable layer resulting in less or no carbonization. In this case, the same layer composition can be used for the first and second laser markable layers, thereby reducing the cost for manufacturing the security documents. It is also possible to use a first laser markable layer which is intrinsically more sensitive than the second markable layer but then the interposed layer should more than compensate this difference in laser sensitivity.

A simple test to determine if the second laser markable layer exhibits a higher laser sensitivity than a non-laser marked area of the first laser markable layer is by laser marking a non-laser marked area of the security document and to check in which laser markable layer the optical density is first created. If the optical density is first created in the second laser markable layer, then the second laser markable layer exhibits a higher laser sensitivity than a non-laser marked area of the first laser markable layer.

The security document according to the present invention may also have one or more laser markable layers on the other side of the support as the side carrying the first laser markable layer. In a preferred embodiment, the same concept is employed of a first and second laser markable layer wherein the second laser markable layer exhibits a higher laser sensitivity than a non-laser marked area of the first laser markable layer but produces a smaller maximum optical density or a smaller gloss on laser marking. In a more preferred embodiment, the security document precursor is symmetrical around the support, i.e. having the same layers in the same order on both sides of the support as shown by FIG. 2. This has the advantage that no error can be made during production of the security document.

The security document according to the present invention may be a “smart card”, meaning an identification card incorporating an integrated circuit as a so-called electronic chip. In a preferred embodiment the security document is a so-called radio frequency identification card or RFID-card.

The security document according to the present invention is preferably an identification card selected from the group consisting of an identity card, a security card, a driver's licence card, a social security card, a membership card, a time registration card, a bank card, a pay card and a credit card. In a preferred embodiment, the security document according to the present invention is a personal identity card.

A large set of security cards is preferably prepared on a large carrier of information such as a web or sheet by a step and repeat process, after which the information carrier is cut into multiple items with the appropriate dimensions each representing a personal ID card, preferably according to the format specified by ISO/IEC 7810. ISO 7810 specifies three formats for identification cards: ID-1 with the dimensions 85.60 mm×53.98 mm, a thickness of 0.76 mm is specified in ISO 7813, as used for bank cards, credit cards, driving licences and smart cards; ID-2 with the dimensions 105 mm×74 mm, as used in German identity cards, with typically a thickness of 0.76 mm; and ID-3 with the dimensions 125 mm×88 mm, as used for passports and visa's. When the security cards include one or more contactless integrated circuits then a larger thickness is tolerated, e.g. 3 mm according to ISO 14443-1.

### Supports

The support of the security document according to the present invention is should be sufficiently thick to be self-supporting, but thin enough to be flexed, folded or creased without cracking. Preferably, the support has a thickness of between about 7 μm and about 250 μm, more preferably between about 10 μm and about 125 μm, most preferably between about 10 μm and about 60 μm.

The support preferably comprises at least one layer, but can be a multilayered laminate or co-extrudate. Such multilayer laminates include paper/polymer laminates. Examples of suitable co-extrudates are PET/PETG and PET/PC.

The support for use in the present invention can be transparent, translucent or opaque, and can be chosen from paper type and polymeric type supports well-known from photographic technology. In a preferred embodiment the support is an opaque support.

Paper types include plain paper, cast coated paper, polyethylene coated paper and polypropylene coated paper.

Polymeric supports include cellulose acetate propionate or cellulose acetate butyrate, polyesters such as polyethylene terephthalate and polyethylene naphthalate, polyamides, polycarbonates, polyimides, polyolefins, poly(vinylacetals), poluyvinylchlorides, polyethers and polysulphonamides. Also synthetic paper can be used as a support.

Other examples of useful high-quality polymeric supports for the present invention include opaque white polyesters and extrusion blends of polyethylene terephthalate and polypropylene. Also Teslin™ may be used as support.

Polyester film supports and especially polyethylene terephthalate are preferred because of their excellent properties of dimensional stability. When such a polyester is used as the support material, a subbing layer may be employed to improve the bonding of the image receiving layer of the silver diffusion transfer process to the support. Useful subbing layers for this purpose are well known in the photographic art and include, for example, polymers of vinylidene chloride such as vinylidene chloride/acrylonitrile/acrylic acid terpolymers or vinylidene chloride/methyl acrylate/itaconic acid terpolymers.

In a preferred embodiment of the security document according to the present invention, the support is polyvinyl chloride, polycarbonate or polyester, with coloured or whitened polyvinyl chloride, polycarbonate or polyester being preferred. The polyester support is preferably polyethylene terephthalate support (PET) or polyethylene terephthalate glycol (PETG).

Instead of a coloured or whitened support, an opacifying layer can be coated onto the support. Such opacifying layer preferably contains a white pigment with a refractive index greater than 1.60, preferably greater than 2.00, and most preferably greater than 2.60. The white pigments may be employed singly or in combination.

Suitable white pigments include C.I. Pigment White 1, 3, 4, 5, 6, 7, 10, 11, 12, 14, 17, 18, 19, 21, 24, 25, 27, 28 and 32. Preferably titanium dioxide is used as pigment with a refractive index greater than 1.60. Titanium oxide occurs in the crystalline forms of anatase type, rutile type and brookite type. In the present invention the rutile type is preferred because it has a very high refractive index, exhibiting a high covering power.

In one embodiment of the security document according to the present invention, the support is an opacified polyvinyl chloride, an opacified polycarbonate or an opacified polyester.

### Laser Markable Layers

Laser marking produces a colour change in a laser markable layer through carbonization of the polymer in the layer caused by local heating. Patent literature and other literature contain contradictory statements regarding the necessity of specific “laser additives” for one polymer or another. This is presumably because particular additives which are regularly added to plastics for other purposes (for example as a filler, for colouring or for flame retardation) can also promote the laser marking result. The literature particularly frequently mentions polycarbonate, polybutylene terephthalate (PBT) and Acrylonitrile Butadiene Styrene (ABS) as “laser-markable even without additive”, but additives are often added even in the case of these polymers in order to improve the laser markability further.

The first laser markable layer can be present as a self-supporting layer or as a layer on a support.

In a preferred embodiment of the security document according to the present invention, the self-supporting layer contains polyvinyl chloride, polycarbonate or polyester, with coloured or whitened polyvinyl chloride, polycarbonate or polyester being preferred.

### Polymers for Laser Marking

Any polymer suitable for laser marking, i.e. carbonization, may be used in the security document according to the present invention. Preferred polymers include polycarbonate (PC), polyethylene terephthalate (PET), polybutylene terephthalate (PBT), polyvinyl chloride (PVC), polystyrene (PS) and copolymers thereof, such as e.g. aromatic polyester-carbonate and acrylonitrile butadiene styrene (ABS). A mixture of two or more of these polymers may also be used.

In a preferred embodiment of the security document according to the present invention, the first and/or second laser markable layer contains polycarbonate or a copolymer thereof.

In order to promote and to support the colour change in polymeric materials, various additives have been developed. As a result of the addition of a “laser additive”, a substance which absorbs the laser light and converts it to heat, the heat input and the carbonization can be improved. This is the case even for polymers such as polycarbonate which carbonize readily on their own. Laser-markable plastics which are difficult to laser-treat include polyethylene, polypropylene, polyamide, polyoxymethylene, polyester, polymethyl methacrylate, polyurethane or a copolymer thereof.

### Laser Additives

Suitable laser additives include antimony metal, antimony oxide, carbon black, mica (sheet silicate) coated with metal oxides and tin-antimony mixed oxides. In WO 2006/042714 (TICONA), the dark coloration of plastics is obtained by the use of additives based on various phosphorus-containing mixed oxides of iron, copper, tin and/or antimony.

In a preferred embodiment of the security document according to the present invention, the first and/or second laser markable layer contains carbon black particles. This avoids the use of heavy metals, which are less desirable from an ecology point of view, in manufacturing these security documents, but may also cause problems for persons having a contact allergy based on heavy metals.

Suitable carbon blacks include Pigment Black 7 (e.g. Carbon Black MA8™ from MITSUBISHI CHEMICAL), Regal™ 400R, Mogul™ L, Elftex™ 320 from CABOT Co., or Carbon Black FW18, Special Black 250, Special Black 350, Special Black 550, Printex™ 25, Printex™ 35, Printex™ 55, Printex™ 90, Printex™ 150T from DEGUSSA.

The use of these laser additives may lead to an undesired background colouring of the security document. For example, a too high concentration of carbon black in a laser markable layer based on polycarbonate leads to grey security documents. If a white background is requested for the security document, then a white pigment may be added to the composition for manufacturing the laser markable layer. Preferably a white pigment with a refractive index greater than 1.60 is used. A preferred pigment is titanium dioxide.

However, most white pigments with a refractive index greater than 1.60, such as titanium dioxide, also have a high specific density resulting in problems of dispersion stability of the laser markable compositions used for making the laser markable layer. Both problems of white background and dispersion stability were solved in the present invention by using a dispersion of carbon black particles having a small average size and present in a low concentration.

The numeric average particle size of the carbon black particles is preferably between 5 nm and 250 nm, more preferably between 10 nm and 100 nm and most preferably between 30 nm and 60 nm. The average particle size of carbon black particles can be determined with a Brookhaven Instruments Particle Sizer BI90plus based upon the principle of dynamic light scattering. The measurement settings of the BI90plus are: 5 runs at 23° C., angle of 90°, wavelength of 635 nm and graphics=correction function.

For avoiding grey background colouring of security document, carbon black is preferably present in a concentration of less than 0.1 wt %, more preferably in the range 0.005 to 0.03 wt %, based on the total weight of the laser markable polymer(s).

### Blowing Agents

In a preferred embodiment of the security document according to the present invention, the second laser markable layer contains a blowing agent.

A blowing agent is a chemical added to plastics and rubbers that generates inert gases on heating. It is normally used for causing the resin to assume a cellular structure. In the present invention it was observed that the use of a blowing agent reduced the maximum optical density obtainable with the second laser markable layer even further.

Suitable blowing agents include those in U.S. Pat. No. 4,737,523 (MOBAY), U.S. Pat. No. 4,728,673 (BAYER), U.S. Pat. No. 4,683,247 (GENERAL ELECTRIC), U.S. Pat. No. 4,616,042 (GENERAL ELECTRIC), U.S. Pat. No. 4,587,272 (GENERAL ELECTRIC) and U.S. Pat. No. 4,544,677 (GENERAL ELECTRIC), which are hereby incorporated by reference.

Preferred blowing agents according to the present invention have gas generation temperatures measured at standard pressure of at least 10° C. above the lamination temperature of the second laser markable layer.

In a preferred embodiment, the gas generation temperature measured at standard pressure of the blowing agent is at least 180° C., more preferably at least 200° C.

Some exemplary blowing agents useful in the practice of the present invention include nitroso compounds, semicarbazide compounds, tetrazole compounds, oxalate compounds, triazine compounds, dihydrooxadiazinione compounds and combinations thereof. Particularly preferred compounds include 5-pheny-3,6-dihydro-1,3,4-oxadiazin-2-one (“PDOX”) and 5-phenyl tetrazole

5-phenyl tetrazole is particularly preferred because at a lamination temperature of 160° C. no blowing-effect is observed.

The blowing agent is preferably used in a concentration of up to 15 wt % %, based on the total weight of the laser markable polymer(s).

### Interposed Layers

In one embodiment, the construction of the security document is adapted by interposing a layer between the first and second laser markable layer which reduces the infrared light transmission at a wavelength between 750 and 1400 nm to no more than 90%, more preferably no more than 75% and most preferably no more than 50%.

In order to reduce the infrared light transmission and thus the infrared laser light for marking the first laser markable layer, the interposed layer contains an infrared radiation absorbing compound.

### Infrared Radiation Absorbing Compound

The infrared radiation absorbing compounds may be pigments such as e.g. carbon black but are preferably dyes, hereinafter referred to as IR-dye, such as cyanine, merocyanine, indoaniline, oxonol, pyrilium and squarilium dyes.

The advantage of using IR-dyes that, unlike carbon black, a high absorbance in the infrared region can be combined with a low absorbance in the visible region, thereby avoiding undesired background colouring of the security document.

The interposed layer has preferably an IR absorbance of at least 0.1, more preferably of at least 0.3 within the range of 750-1400 nm and an optical density of less than 0.03 in the visible region (400-700 nm).

A combination of one or more infrared radiation absorbing compounds, more specifically IR-dyes, may also be used. A disadvantage of an IR-dye is that the absorbance in the IR-region usually contains one or more peaks and does represent not a “block”-like absorbance. By combining one or more IR-dyes a “block”-like absorbance can be obtained which is effective in reducing the infrared light transmission of the interposed layer for different laser wavelengths.

### Polymeric Overlays

The security document according to the present invention has at least one polymer overlay on top of the first laser markable layer. The security document may have several polymeric overlays on top of each other, for example, each containing some information or security features applied by imaging techniques such as ink-jet printing, intaglio printing, screen printing, flexographic printing, driographic printing, electrophotographic printing, electrographic printing and offset printing.

In one embodiment of the security document according to the present invention, the at least one polymer overlay is sealed to the first laser markable layer.

Suitable polymeric overlays which are laminated or coated include cellulose acetate propionate or cellulose acetate butyrate, polyesters such as polyethylene terephthalate and polyethylene naphthalate, polyamides, polycarbonates, polyimides, polyolefins, polyvinylchlorides, poly(vinylacetals), polyethers and polysulphonamides.

In a preferred embodiment of the security document according to the present invention, the polymeric overlay is polyvinyl chloride, polycarbonate or polyester. The polyester is preferably polyethylene terephthalate (PET) or polyethylene terephthalate glycol (PETG).

### Methods of Producing Security Document

The method of manufacturing a security document according to the present invention includes the steps of:

a) providing a laser markable security document precursor having in order a support, a first laser markable layer and at least one polymeric overlay;

b) applying an image to the first laser markable layer by laser marking through the polymeric overlay; and

c) applying a second laser markable layer on the laser marked security document precursor on the same side of the support as the first laser markable layer;

wherein the second laser markable layer exhibits a higher laser sensitivity than a non-laser marked area of the first laser markable layer, but produces a smaller maximum optical density or a smaller gloss on laser marking.

In a preferred embodiment of the method of manufacturing a security document according to the present invention, the second laser markable layer contains a plasticizer.

Often a laser markable layer is first coated on a temporary support and then laminated at high temperature on the security document support already carrying one or more layers. In the present invention the lamination at 160° C. of the second markable layer based on polycarbonate resulted in adhesion problems. The adhesion could be improved by increasing the lamination temperature, but this proved to be impossible because a physical distortion of the image present in the first laser markable layer was observed. The use of a plasticizer in the second laser markable layer allowed a lower lamination temperature to be used causing no image distortion while exhibiting excellent adhesion.

Alternatively the second laser markable layer can also be coated directly onto the polymeric overlay. However, this requires the presence of a coating device in the equipment for manufacturing the security document, which represents a more costly and complex tool than a laminator, leading to higher production costs.

In another embodiment, the second laser markable layer is applied by a thermal transfer printing process as used for applying varnish layers on top of dye sub printed colour images or by using hot foil stamping technology if only part of the card needs to be laser protected.

Therefore, it is preferred to laminate the second laser markable layer onto the polymeric overlay. The lamination temperature is preferably no higher than 180° C., more preferably no higher than 170° C. and most preferably no more than 160° C.

Usually to prevent forgeries of identification documents, different means of securing are used, e.g. guilloches and holograms. These solutions make it possible to secure documents adequately, but they require additional equipment and/or material, leading to higher production costs. The method of producing a security document according to the present invention allows the securization of a security document which is simple to implement and makes it possible to reduce production costs.

### Laser Marking

Laser marking in the present invention involves the carbonization of material from a laser markable layer.

The laser used in the laser marking can be any laser as long as it is able to form a pattern by carbonization of the material in the laser markable layer. In order to carry out the laser marking with high speed, a laser having a high power is desirable. A preferred example of such a has an emitting wavelength in an infrared region or near infrared region, for example, a carbon dioxide gas laser, a YAG laser, a semiconductor laser or a fiber laser. Also, an ultraviolet laser having an emitting wavelength in an ultraviolet region, for example, an excimer laser, a YAG laser wavelength-converted to the third harmonic or the fourth harmonic or a copper vapour laser is also able to conduct ablation processing which cleaves a bond between molecules of organic compound and thus is suitable for microfabrication. A laser having an extremely high peak power, for example, a femtosecond laser can also be employed. The laser irradiation may be performed continuously or pulse wise.

Preferred lasers for laser engraving in the present invention are CO₂-lasers and Nd-YAG lasers. Fiber lasers can also be used.

Although the laser marking is conducted under oxygen-containing gas, ordinarily in the presence of air or in airflow, it can be conducted under carbon dioxide gas or nitrogen gas.

### Other Security Features

To prevent forgeries of security documents, different means of securing may be used in the security document according to the present invention. One solution consists in superimposing lines or guilloches on an identification picture such as a photograph. In that way, if any material is printed subsequently, the guilloches appear in white on added black background. Other solutions consist in adding security elements such as holograms, information printed with ink that reacts to ultraviolet radiation, micro-letters concealed in an image or text etc.

The security document according to the present invention may contain other security features such as anti-copy patterns, guilloches, endless text, miniprint, microprint, nanoprint, rainbow colouring, 1D-barcode, 2D-barcode, coloured fibres, fluorescent fibres and planchettes, fluorescent pigments, OVD and DOVID (such as holograms, 2D and 3D holograms, Kinegrams™), overprint, relief embossing, perforations, metallic pigments, magnetic material, Metamora colours, microchips, RFID chips, images made with OVI (Optically Variable Ink) such as iridescent and photochromic ink, images made with thermochromic ink, phosphorescent pigments and dyes, watermarks including duotone and multitone watermarks, ghost images and security threads.

A combination with one of the above security features increases the difficulty for falsifying a security document.

### EXAMPLE

### Materials

All materials used in the following examples were readily available from standard sources such as ALDRICH CHEMICAL CO. (Belgium) and ACROS (Belgium) unless otherwise specified.

PC01 is an abbreviation used for polycarbonate Apec™ 2050 available from BAYER.

C01 is an abbreviation used for the carbon black powder Printex™ 25 van DEGUSSA having Particle Size of 56 nm and BET Surface area of 45 m²/g.

TCP is an abbreviation used for tricresylphosphate available from BAYER.

S01 is an abbreviation used for the silicon oil Baysilon™ OI A available from BAYER and used as a surfactant.

MEK is an abbreviation used for methylethylketon.

5FT is an abbreviation used for 5-phenyltetrazole available from ALDRICH.

PET100 is a 100 μm unsubbed PET substrate with on the backside an anti-blocking layer with antistatic properties available from AGFA-GEVAERT as P100C PLAIN/ABAS.

Makrofol™ ID 4-4 white is an opaque extrusion film based on Makrolon™ from BAYER.

Makrofol™ DE 1-4 is a translucent extrusion film based on Makrolon™ (polycarbonate) from BAYER.

Makrofol™ DE 1-1 is a transparent extrusion film based on Makrolon™ (polycarbonate) from BAYER.

### Measurements

### 1. Optical Density (OD)

The optical density was measured in reflection using a spectrodensitometer Type 504 from X-RITE using a visual filter.

### 2. Gloss (G)

The gloss was measured at an angle of 20° with a REFO3-D available from Dr. LANGE GmbH, Germany.

### Example 1

This example illustrates the manufacturing of a security document according to the present invention, including the advantages observed by including plasticizers and blowing agents in the second laser markable layer.

### Preparation of a Security Document Precursor SDP-1

In a first step a security document precursor is prepared having a support and a first laser markable layer.

A laser markable polycarbonate card was made in an Oasys OLA6/7 laminator by laminating different polycarbonate foils at a temperature setting of 205° C. The resulting card build-up was symmetrical and consisted, in order, of the following foils:
125 μm Makrofol™ DE 1-1 (non-laser markable)
50 μm Makrofol™ DE 1-4 (laser markable)
250 μm opaque Makrofol™ ID 4-4 white
250 μm opaque Makrofol™ ID 4-4 white
50 μm Makrofol™ DE 1-4 (laser-markable)
125 μm Makrofol™ DE 1-1 (non-laser markable)

It should be obvious for people skilled in the art that other card structures with different foil-thickness are also useful. Changes in card-structure can, e.g., be done to insert electronics or to obtain asymmetric card structure.

A first test image containing a wedge with different grey-levels (six squares of 9×9 mm) was laser marked in the first laser markable layer, i.e. the 50 μm transparent Makrofol DE 1-4 on one side of the security document precursor SDP-1, using a Rofin RSM Powerline E laser (10 W) with settings 29 ampere and 22 kHz. The optical density and the gloss were measured for squares 3 and 6. Square 6 (RGB-values=12 of this area in bitmap-image) represented a “black area”, while square 3 (RGB-values=157 of this area in bitmap-image) represented a “grey area”.

Preparation of Security Documents with a Second Laser Markable Layer

A carbon black dispersion CD-1 was prepared by mixing the components according to Table 1 using a dissolver and subsequently treating this mixture with a roller mill procedure using steatite-beads of 1 cm diameter for seven days at a rotation speed set at 150 rpm. After milling the dispersion was separated from the beads using a filter cloth. The weight % (wt %) of the components was based on the total weight of the coating composition.

TABLE 1

| Components | wt % |
|---|---|
| PC01 | 20 |
| MEK | 75 |
| C01 | 5 |

A polycarbonate solution PCS-1 was prepared by mixing the components according to Table 2 using a dissolver.

TABLE 2

| Components | Amount |
|---|---|
| PC01 | 80.0 g |
| MEK | 319.0 g |
| S01 | 0.1 g |

The carbon black dispersion CD-1 was diluted by mixing 0.5 g of the carbon black dispersion CD-1 with 68 g of the polycarbonate solution PCS-1 to prepare a carbon black stock dispersion CSD-1.

Then four coating solutions SOL-1 to SOL-4 were prepared according to Table 3.

TABLE 3

| Components | SOL-1 | SOL-2 | SOL-3 | SOL-4 |
|---|---|---|---|---|
| PCS-1 | 39 g | 39 g | 36 g | 36 g |
| CSD-1 | 1 g | 1 g | 4 g | 4 g |
| TCP | — | 2 g | 3 g | 3 g |
| 5FT | — | — | — | 1 g |

The coating solutions SOL-1 and SOL-2 contain 46 ppm carbon black, while coating solutions SOL-3 and SOL-4 contain 182 ppm carbon black with respect to the polycarbonate.

The coating solutions SOL-1 to SOL-4 were then coated with an Elcometer Bird Film Applicator (from ELCOMETER INSTRUMENTS) on a PET100 substrate at a coating thickness of 120 μm and subsequently dried for 15 minutes in oven at 80° C. to respectively deliver the laminates LAMSOL-1 to LAMSOL-4.

The laminates LAMSOL-1 to LAMSOL-4 were then laminated on both sides of the laser marked security document precursor SDP-1 to deliver laser marked security documents SD-1 to respectively SD-4 using either a GMP Excellam™ 655Q hot roll laminator or using a Oasys™ OLA6/7 Desktop Plate Laminator. After lamination the temporary support PET100 was removed.

The GMP Excellam™ 655Q hot roll laminator was set at a lamination temperature of 160° C., a distance of 1 mm between the rolls, a speed setting of 1 and inserting the laminates protected between a silicon based paper (Codor-carrier No 57001310 from CODOR) to prevent sticking to laminator rolls.

The Oasys™ OLA6/7 Desktop Plate Laminator was set at a lamination temperature of 160° C. and a pressure setting of 40.

The optical density of the laser marked squares 3 and 6 in the first laser markable layer was again measured.

Subsequently the same test image of the security document precursor SDP-1 was laser marked on each of the laminated, laser marked security document SD-1 to SD-4, using the same setting of the Rofin RSM Powerline E laser. The optical density (OD) and the gloss (G) were measured for squares 3 and 6 of this second test image on each of the laminated, laser marked security documents SD-1 to SD-4. The results are shown in Table 4.

TABLE 4

| | | First test image | | | | Second test image | | | |
|---|---|---|---|---|---|---|---|---|---|
| | | Square 3 | | Square 6 | | Square 3 | | Square 6 | |
| Sample | Laminator | OD | G | OD | G | OD | G | OD | G |
| SDP-1 | — | 0.86 | 62 | 2.06 | 67 | — | — | — | — |
| SD-1 | Oasys | 0.76 | 39 | 1.68 | 35 | 0.91 | 32 | 1.57 | 3 |
| SD-2 | Oasys | 0.88 | 69 | 2.04 | 68 | 0.86 | 37 | 1.29 | 3 |
| SD-3 | Excellam | 0.86 | 92 | 2.07 | 79 | 0.89 | 54 | 1.49 | 1 |
| SD-4 | Oasys | 0.83 | 91 | 1.93 | 78 | 0.83 | 56 | 0.99 | 2 |

Sample SD-1, lacking the plasticizer TCP, exhibited adhesion problems which did not occur in any of the other samples SD-2 to SD-4. All samples SD-2 to SD-4 exhibited a good scratchability of the surface even though a plasticizer was present. On an identical sample as SD-1, but laminated at 210° C., the adhesion problem was solved, but then the first test image was distorted.

From Table 4, it should be clear that the maximum optical density and gloss of square 6 in the second test image of samples SD-1 to SD-4 was considerable lower than that obtained for the first test image. The use of a blowing agent in the second laser markable layer of sample SD-4 produced a very low maximum optical density.

1-14. (canceled)

15. A security document comprising in order:
(a) a first laser markable layer present as a self-supporting layer or as a layer on a support;
(b) at least one polymeric overlay; and
(c) a second laser markable layer;
wherein the second laser markable layer exhibits a higher laser sensitivity than a non-laser marked area of the first laser markable layer, but produces a smaller maximum optical density or a smaller gloss on laser marking.

16. The security document according to claim 1, further comprising a layer interposed between the first and second laser markable layer which reduces the infrared light transmission at a wavelength between 750 and 1400 nm to no more than 90%.

17. The security document according to claim 1, wherein the first and/or second laser markable layer contains polycarbonate or a copolymer thereof.

18. The security document according to claim 1, wherein the first and/or second laser markable layer contains carbon black particles.

19. The security document according to claim 1, wherein the second laser markable layer contains a plasticizer.

20. The security document according to claim 1, wherein the second laser markable layer contains a blowing agent.

21. The security document according to claim 1, wherein the second laser markable layer is the outermost layer.

22. A method of manufacturing a security document comprising the steps of:
(a) providing a laser markable security document precursor comprising, in order, a first laser markable layer present as a self-supporting layer or as a layer on a support, and at least one polymeric overlay;
(b) applying an image to the first laser markable layer by laser marking through the polymeric overlay; and
(c) applying a second laser markable layer on the laser marked security document precursor on the same side of the support as the first laser markable layer, wherein the second laser markable layer exhibits a higher laser sensitivity than a non-imaged area of the first laser markable layer after step c but produces a smaller maximum optical density or a smaller gloss on laser marking.

23. The method of manufacturing a security document according to claim 22, wherein the precursor further comprises a layer interposed between the first and second laser markable layer which reduces the infrared light transmission at the wavelength of the laser used for laser marking to no more than 90%.

24. The method of manufacturing a security document according to claim 22, wherein the first and/or second laser markable layer contains polycarbonate or a copolymer thereof.

25. The method of manufacturing a security document according to claim 22, wherein the first and/or second laser markable layer contains carbon black particles.

26. The method of manufacturing a security document according to claim 22, wherein the second laser markable layer contains a plasticizer.

27. The method of manufacturing a security document according to claim 22, wherein the second laser markable layer contains a blowing agent.

28. The method of manufacturing a security document according to claim 22, wherein the second laser markable layer is the outermost layer.

29. A security document prepared by the method of claim 22.
